(19) United States
(12) Patent Application Publication
(10) Pub. No.: US 2016/0110644 A1
(43) Pub. Date: Apr. 21, 2016

(54) Time Correlation Learning Neuron Circuit Based on a Resistive Memristor and an Implementation Method Thereof

(71) Applicant: PEKING UNIVERSITY, Beijing (CN)

(72) Inventors: Ru Huang, Beijing (CN); Yaokai Zhang, Beijing (CN); Yimao Cai, Beijing (CN); Fan Yang, Beijing (CN); Yue Pan, Beijing (CN); Zongwei Wang, Beijing (CN); Yichen Fang, Beijing (CN)

(21) Appl. No.: 14/892,130

(22) PCT Filed: Sep. 30, 2013
(86) PCT No.: PCT/CN2013/084752

§ 371 Date: Nov. 18, 2015

(30) Foreign Application Priority Data
May 24, 2013 (CN) 201310197061.7

(51) Int. Cl. G06N 3/08; G06N 3/04

(52) U.S. Cl. CPC G06N 3/08; G06N 3/049

(57) ABSTRACT

The present invention discloses a time correlation learning neuron circuit based on a resistive memristor and an implementation method thereof. The present invention utilizes switching characteristics of the resistive memristor. When two terminals of the resistive memristor are selected synchronously by two excitation signals, the voltage drop between these two terminals will change the resistance value of memristor, thereby achieving the on-off of a synapse connection and achieving the correction of the two excitation signals. Meanwhile the device also has a memory characteristic. Also, the previous excitation signal can be repeated. That is, the purpose of learning is achieved. Since the resistive memristor has a simple structure and a high degree of integration, it can achieve large-scale physical synapse connection in order to achieve more complex learning and even logic functions. The present invention has a good application prospect in a neuron cell computation.

### TECHNICAL FIELD

The invention refers to a neuron cell circuit, and more particularly, to a time correlation learning neuron circuit based on a resistive memristor and an implementation method thereof.

### BACKGROUND OF THE INVENTION

A digital computer is an important product that the human technological civilization advances in the twentieth century, and its influence permeate every aspect of people's lives. However, with the development of the computer industry and the progress of the microelectronics industry, the functions of the current computer have not met people's requirements, high computing speed, large storage capacity and intelligent have become an inevitable trend in the future development of the computer. A neural computer becomes a powerful replacement of the current computer due to it has characteristics of a massively parallel processing, a strong identification ability, a ability of processing analog information, a machine self-learning and so on. Otherwise, its hardware manufacturing lies in good weight interconnections which can be integrated massively. In a neuron cell circuit, a great deal of synapse connections need to be used, and these synapse connections must have variable weights and smaller sizes to facilitate large-scale integration. For the resistive memristor as the synapse connection in the neuron cell circuit, the resistance value of the resistive memristor is the weight value of a synapse. A memristor has characteristics of simple structure, small size, easily large-scale integration, continuous change of the resistance value, etc., so it provides a good device base for a hardware implementation of the neural computer. Therefore, the neuron cell circuit based on the resistive memristor has been widely studied.

Computing functions of the digital computer in the prior art have been completed in a design phase, while after completing the computer design, the computer reproduce the set logic, and does not have autonomous learning ability and true sense of learning function.

### SUMMARY OF THE INVENTION

For existing problems in the prior art, the present invention provides a novel neuron circuit, which is capable of achieving a basic learning and memory function of a biological neuron.

An object of the present invention is to provide a time correlation learning neuron circuit based on a resistive memristor.

A time correlation learning neuron circuit based on a resistive memristor of the present invention includes two neuron cell circuits and a resistive memristor as a synapse connection between the two neuron cell circuits; further, each neuron cell circuits include a excitation signal terminal, a synapse connection terminal, a buffer, a control signal inverter, a first transmission gate and a second transmission gate; wherein,

An output terminal of the buffer is connected to the excitation signal terminal, and an input terminal of the buffer is connected to one signal terminal of the second transmission gate;

An input terminal of the control signal inverter is connected to the excitation signal terminal, a positive control terminal of the first transmission gate and a negative control terminal of the second transmission gate, and a output terminal of the control signal inverter is connected to a negative control terminal of the first transmission gate and a positive control terminal of the second transmission gate;

One signal terminal of the first transmission gate is connected to a voltage source, the other signal terminal of the first transmission gate is connected to the synapse connection terminal, the positive control terminal of the first transmission gate is connected to the excitation signal terminal, and the negative control terminal of the first transmission gate is connected to the output terminal of the control signal inverter;

One signal terminal of the second transmission gate is connected to the input terminal of the buffer, the other signal terminal of the second transmission gate is connected to the synapse connection terminal, the positive control terminal of the second transmission gate is connected to the excitation signal terminal, and the negative control terminal of the second transmission gate is connected to the output terminal of the control signal inverter.

The resistive memristor is a sandwich structure, including a top electrode, a bottom electrode, and a resistive material filled between the top electrode and the bottom electrode. The materials between the top electrode and the bottom electrode are the metal. The resistive memristor is a resistor programmed by a voltage, i.e., may change a resistance value of a device by applying a certain voltage. Such devices have been widely studied in the current academic fields. According to a polarity of a programming voltage, such devices may be divided into a unipolar resistive memristor and a bipolar resistive memristor. A correlation between the two neuron cell circuits is determined by the resistive memristor which is used as the synapse connection of the two neuron cell circuits. When a resistance value of the resistive memristor is maximum, a weight of the synapse connection is minimum, thereby the correlation between the two neuron cell circuits is almost zero, i.e., the two neuron cell circuits are not affected with each other; and when the resistance value of the resistive memristor is decreased, the weight of the synapse connection is increased, thereby a greater correlation between the two neuron cell circuits is generated so that the correlation between two excitation signals generated by the two neuron cell circuits is created.

Two neuron cell circuits are one front neuron cell circuit and one back neuron cell circuit, respectively, wherein a control terminal of a first transmission gate of the front neuron cell circuit is connected to a positive voltage source, and a control terminal of a first transmission gate of the back neuron cell circuit is connected to a negative voltage source. A synapse connection terminal of the front neuron cell circuit is connected to the top electrode of the resistive memristor by metal connection wires; a synapse connection terminal of the back neuron cell circuit is connected to the bottom electrode of the resistive memristor by metal connection wires. The front neuron cell circuit applies a positive voltage to the resistive memristor by the synapse connection terminal when receiving a excitation signal, and the back neuron cell circuit applies a negative voltage to the resistive memristor by the synapse connection terminal when receiving a excitation signal. In this way, a larger voltage difference is generated at two terminals of the resistive memristor when two excitation signals are received simultaneously so that the resistance value of the resistive memristor is decreased. The excitation signal terminal of the neuron cell circuit may be used as an input terminal of the excitation signal, and may also be used as an output terminal of the excitation signal. When the excitation signal terminal of the neuron cell circuit is used as the input terminal of the excitation signal, the excitation signal is input from the excitation signal terminal, and is connected to the positive control terminal of the first transmission gate, thereby a voltage source signal which is provided by the voltage source can be applied to the synapse connection terminal by turning on the first transmission gate and turning off the second transmission gate. When the excitation signal terminal of the neuron cell circuit is used as the output terminal of the excitation signal, it is used as the output terminal of the buffer, and the input terminal of the buffer is connected to the synapse connection terminal. The buffer is an even number of inverters connected in series to increase the drivability of the next stage circuit, thus making the voltage more stable.

A principle of the invention is briefly illustrated below.

Firstly, a basic mode of human learning is cognize, that is, cognizing an object simultaneously requires an image signal itself which is input to the brain through eyes and a sound signal for explaining the object which is input to the brain through ears. Both of them are used as basic elements of such object learning. Only the image signal and the sound signal are inputted simultaneously, a correlation of the image of the object and a sense of the object is created in the brain, and when one of the image signal and the sound signal is input next time, the memory of the other may be waked up by “thinking”, that is, a learning and memory function for a object is realized. The strength of such learning and memory is determined by the strength of the synapse correlation, which is determined by the length of learning time. This time correlation learning and memory mode is very similar to resistive characteristics of the resistive memristor studied widely, which is also a theoretical basis of the present invention.

Then, an implementation principle of the present invention is briefly illustrated. When simultaneously receiving respective excitation circuit signals, two neuron cell circuits generate stress signals which may be applied to the resistive memristor connected thereto by metal connection wires for the respective excitation signals, respectively. When the two excitation signals are excited simultaneously, the voltage difference that the resistive value of the resistive memristor is changed is formed on the resistive memristor. At the beginning, the resistance value is greater, and then the resistance value is gradually decreased with the duration of the excitation, i.e., the weight of the synapse connection is smaller at the beginning and then becomes greater, until one of the excitation signals ends, because a cognition process requires that the two excitation signals are conducted simultaneously. After the excitation signal ends, the resistance value of the resistive memristor is constant, which is equivalent to the memory of the learning process. The changed resistive memristor which is precisely the resistive memristor in which resistance value is decreased makes a stronger correlation between the two neuron cell circuits be generated, that is, the weight of the synapse connection is increased, and the probability that the excitation signal of one cell circuit is perceived by another cell circuit is increased. The purpose of the learning and cognition is memory, and may reversely repeat signals of a previous cognized object accurately. Any one of the two neuron cell circuits will affect another neuron cell circuit by connecting with a synapse through the excitation signal itself when receiving a previous learned excitation signal again, and the another neuron cell circuit generate a corresponding excitation signal, i.e., the other one of the two excitation signals between which correlation is generated. So far, the learning process of a neural network circuit simulating the human learning and cognition is completed by using the resistive characteristics of the resistive memristor.

An another purpose of the present invention is to provide an implementation method for conducting a time correlation learning by using a time correlation learning neuron circuit based on a resistive memristor.

The implementation method for conducting the time correlation learning by using the time correlation learning neuron circuit based on the resistive memristor according to the present invention, comprises the following steps of:

firstly, creating a correlation

1) Two neuron cell circuits receive two different excitation signals from excitation signal terminals, respectively;

2) The two excitation signals overlap in time. During the overlapping period of time, a resistance value of the resistive memristor is gradually decreased;

3) When one of the two excitation signals ends, the resistance value of the resistive memristor will be constant.

Secondly, repeating

When receiving a previous learned excitation signal again, any one of the two neuron cell circuits will affect another neuron cell circuit by outputting a stress signal itself through the resistive memristor, and the another neuron cell circuit generates a corresponding excitation signal.

In the present invention, where the overlapping time of the two excitation signals is longer, which is equivalent to the time that the correction of the two signals of the same object is created simultaneously being longer, the resistance value of the resistive memristor will be smaller, which is equivalent to the probability that the correlation is created being greater. After the excitation signal ends, the resistance value is constant, which is equivalent to the memory of the signals of the object. When one of the excitation signals occurs again, the probability that the other correlated excitation signal repeatedly occurs is increased. It can be seen that the implementation method of the time correlation learning of the present invention accurately simulates the human learning process.

The advantages of the present invention are that:

The present invention utilizes the switching characteristics of the resistive memristor. When two terminals of the resistive memristor are selected synchronously by the two excitation signals, a voltage drop, which a resistance value of a device may be changed according to it, will be formed at two terminals of the device, thereby achieving the on-off of a synapse connection and achieving the correction of the two excitation signals. Meanwhile, the device has a memory characteristic. Also, the previous excitation signal can be repeated. That is, the purpose of learning is achieved. Since the resistive memristor has a simple structure and a high degree of integration, a large-scale physical synapse connection can be achieved in order to achieve more complex learning and even logic functions. Therefore, the resistive memristor has good prospects in neuron cell computation.

### BRIEF DESCRIPTION OF THE DRAWINGS

FIG. 1 is a structure schematic diagram of a time correlation learning neuron circuit based on a resistive memristor according to the present invention;

FIG. 2 is a interior circuit diagram of a embodiment of a neuron cell circuit according to the present invention;

FIG. 3 is a structure schematic view of a resistive memristor as a synapse connection of a neuron cell circuit according to the present invention;

FIG. 4 is a graph of an operation timing of an embodiment of a resistive memristor according to the present invention.

### DETAILED DESCRIPTION OF THE EMBODIMENTS

The present invention will be further illustrated through examples in connection with the accompanying drawing.

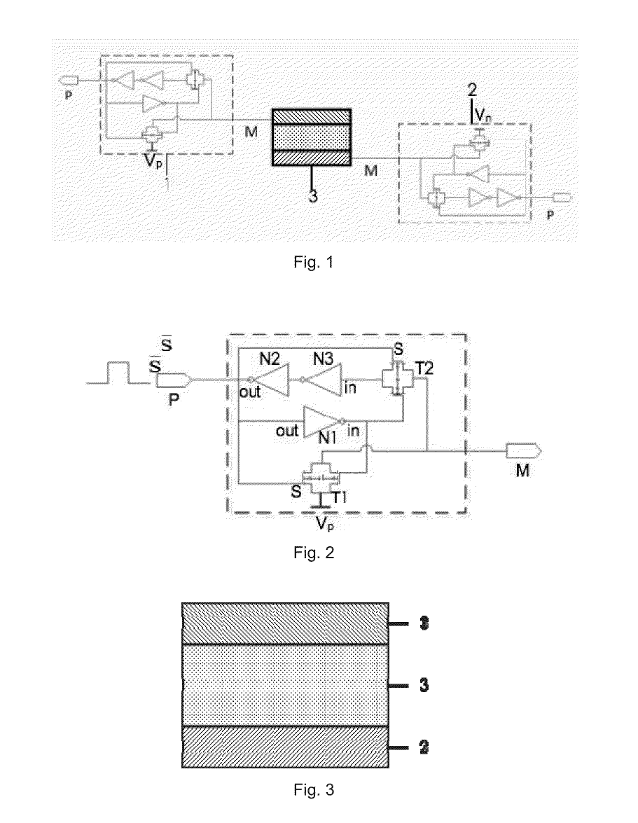

As shown in FIG. 1, a time correlation learning neuron cell circuit based on a resistive memristor of the present invention includes two neuron cell circuits 1 and 2, and a resistive memristor 3 as a synapse connection between the two neuron cell circuits. Further, as shown in FIG. 2, the neuron cell circuit includes a excitation signal terminal P, a synapse connection terminal M, a buffer, a control signal inverter N1, a first transmission gate T1 and a second transmission gate T2; wherein,

An output terminal out of the buffer is connected to the excitation signal terminal P, and an input terminal in of the buffer is connected to one signal terminal of the second transmission gate T2;

An input terminal in of the control signal inverter N1 is connected to the excitation signal terminal P, a positive control terminal S of the first transmission gate T1 and a negative control terminal S̅ of the second transmission gate T2; and an output terminal out of the control signal inverter N1 is connected to a negative control terminal S̅ of the first transmission gate T1 and a positive control terminal S of the second transmission gate T2;

One signal terminal of the first transmission gate T1 is connected to a voltage source; the other signal terminal of the first transmission gate T1 is connected to the synapse connection terminal M; the positive control S of the first transmission gate T1 is connected to the excitation signal terminal P; and the negative control terminal s̅ of the first transmission gate T1 is connected to the output terminal out of the control signal inverter N1;

One signal terminal of the second transmission gate T2 is connected to the input terminal in of the buffer; the other signal terminal of the second transmission gate T2 is connected to the synapse connection terminal M; the positive control terminal S of the second transmission gate T2 is connected to the excitation signal terminal P; and the negative control terminal S̅ of the second transmission gate T2 is connected to the output terminal out of the control signal inverter N1.

In the present embodiment, the buffer is consisting of two inverters N1 and N2 connected in series.

As shown in FIG. 3, the resistive memristor is a sandwich structure, including a top electrode 31, a bottom electrode 32, and a resistive material 33 filled between the top electrode 31 and the bottom electrode 32.

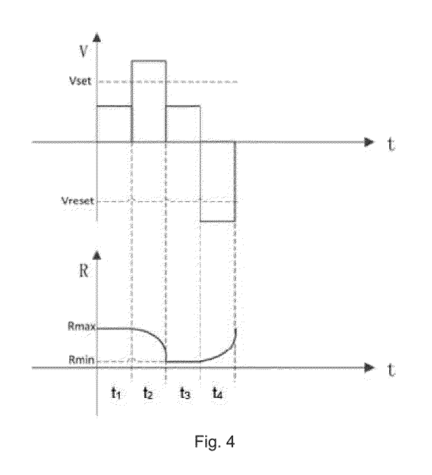

The embodiment uses a bipolar resistive memristor. When a difference of voltage applied to two terminals of the resistive memristor exceeds a threshold value Vset, a resistance value R of the resistive memristor will be changed. Whether the resistance value R is changed to be larger or smaller is determined by a voltage polarity at this time. When the voltage is positive, the resistance value is decreased, and when the voltage is negative, the resistance value is increased. Also, a change of the resistance value presents a non-linear slow change, and a change amount is positively correlated with time t and voltage V. However, when the difference of voltage applied to the two terminals of the resistive memristor is lower than the threshold value, the resistance value R of the resistive memristor will not be changed, which shows a memory characteristic. An operating principle of the resistive memristor is shown in FIG. 4. In a first time period t1, a voltage value is less than a program threshold value, and the resistance value is constant. In the second time period t2, a positive voltage is higher than the program threshold value, and the resistance value be changed from large to small and presents a non-linear slow change, wherein with the increase of time, the change is faster and faster (this mechanism has been confirmed by experiments and theories, and the specific principle of which is not described in detail here), and characteristics thereof are very similar to a mode of the human cognition and learning. In a third time period t3, the voltage value is a voltage that is lower than the threshold value, and the resistance value will be constant, which is equivalent to the memory of the learning process. A diagram in a fourth time period t4 is opposite to a diagram in the second time period t2. In the fourth time period t4, a reverse voltage is applied, and the voltage value is higher than the program threshold value Vreset, thus the resistance value is changed from small to large and presents a non-linear slow change, wherein with the increase of time, the change is slower and slower, which is also consistent with a forgetting rule of the human cognition and learning.

The two neuron cell circuits are a front neuron cell circuit 1 and a back neuron cell circuit 2, respectively. A control terminal of the first transmission gate of the front neuron cell circuit is connected to a positive voltage source Vp, and a control terminal of the first transmission gate of the back neuron cell circuit 2 is connected to a negative voltage source Vn. The front neuron cell circuit 1 applies a positive voltage to the resistive memristor by the synapse connection M when receiving a excitation signal; the back neuron cell circuit 2 applies a negative voltage to the resistive memristor by the synapse connection M when receiving a excitation signal. In this way, when the two excitation signals are received simultaneously, a voltage difference which is greater than the program threshold value is generated at two terminals of the resistive memristor, and the resistance value of the resistive memristor is decreased. The excitation signal terminal P of the neuron cell circuit may be used as an input terminal of the excitation signal, and may also be used as an output terminal of the excitation signal. When the excitation signal terminal P of the neuron cell circuit is used as the input terminal of the excitation signal, the excitation signal is input from the excitation signal terminal, and is connected to the positive control terminal of the first transmission gate T1, thereby a voltage source signal which is provided by an individual voltage source can be applied to the synapse connection terminal M by turning on the first transmission gate T1 and turning off the second transmission gate T2. When the excitation signal terminal of the neuron cell circuit is used as the output terminal of the excitation signal, it is used as the output terminal of the buffer, and the input terminal of the buffer is connected to the synapse connection terminal M. A specific operation process is as follows: when a correlation is created, two excitation signals between which the correction need to be created are input respectively by the excitation signal terminals P of two neuron cell circuits, and then the transmission gates of the two circuits are turned on, thereby stress signals are generated and transmitted to respective M terminals by the transmission gates. Two stress voltage signals having opposite polarities with each other are outwards transmitted to the top electrode and the bottom electrode of the resistive memristor by the M terminals, respectively. Because the current voltage difference exceeds the threshold voltage that the resistance value of the resistive memristor is changed, the resistance value of the resistive memristor is changed. Also, because it is a positive voltage polarity, the resistance value is changed from large to small. The resistance value is decreased, and the corresponding synapse connection weight is increased, that is, one neuron cell circuit makes a probability that the excitation signal is generated in another neuron cell circuit larger when receiving the excitation signal, and that is, the correlation between the two excitation signals or between the two cell circuits occurs. How much the weight increases is determined by a time length of the two excitation signals applied simultaneously. The longer the time is, the greater the weight is and the greater the correlation is, thereby the greater a success rate of the reverse repeat is, and on the contrary, the smaller. This rule is similar to the process of human learning and cognition. After the excitation signal ends, the resistance value of the resistive memristor is constant, which is shown as the memory in the learning. In a reverse repeating process, when receiving individually an excitation signal, any one of the neuron cell circuits generate a stress signal, which will be transferred to the synapse connection terminal M of another neuron cell circuit after multiplied by the synapse weight; when the synapse connection terminal M is used as an input, it is the input terminal of the buffer, and the input stress signal of a preceding stage will form an excitation signal by the buffer at its output terminal, that is, the excitation signal is formed at the excitation signal terminal P of the another neuron cell circuit; the excitation signal in turn causes a stress signal to be generated in the neuron cell circuit, thereby the weight of the synapse connection is increased again. That is to say, every reverse repeat is one deeper learning process. This is similar to the principle of human cognition and learning.

An implementation method of a time correlation learning of the time correlation learning neuron circuit based on a resistive memristor will be described as follows, comprising two parts:

First Step) Creating a Correlation

Any one of two stress voltage signals does not make the resistance value of the resistive memristor change, that is, the amplitude of a single voltage signal does not reach the threshold value that the resistance value of the resistive memristor is changed. However, when a positive voltage signal and a negative voltage signal are superimposed, the voltage difference on the resistive memristor will be a sum of the absolute value of amplitudes of the two voltage signals. It exceeds the threshold value, thus the resistance value of the resistive memristor will be changed, that is, a connection weight between the two neuron cell circuits is begin to change, and a correlation of the excitation signals is created. However, the creation of the correlation occurs only when the two excitation signals is applied simultaneously. That is, when the human learning and cognition is met, the cognition is created only when two learning elements occurs simultaneously.

Second Step) Repeating

The above function is the first step of the learning and cognition, while completing the function of learning also needs to reversely repeat previous learning contents. The repeat process in the present neuron cell circuit is that when one of the two excitation signals occurs, another excitation signal will be automatically generated. Whether in the front neuron cell circuit or in the back neuron cell circuit, when receiving a previous excitation signal again, one of the front neuron cell circuit and the back neuron cell circuit transmit the excitation signal to the resistive memristor as the synapse connection of another neuron cell circuit by a stress signal. At this time, because the resistance value is small and the synapse connection weight is very large, that is, there is a stronger correlation between the front neuron cell circuit and the back neuron cell circuit, the stress signal is multiplied by the weight and input to the another neuron cell circuit, and another excitation signal for which the correlation is previously created is generated by the buffer. So far, the reverse repeating process is completed successfully. It is worth to mention that the stress signal will be generated again in the neuron cell circuit by the excitation signal generated repeatedly, so the synapse connection between the two cell circuits will learn again, that is, the resistance value of the resistive memristor is further reduced, and the synapse connection weight is further increased. It can be seen that every reverse repeat is a reinforcement learning for the previous learning and cognition, that is, further increases the correlation between the two signals, which is consistent with a diligent practice and practice makes perfect rule in the human learning and cognition.

So far, the design circuit completes a process of simulating the human cognition and learning as originally desired. The cognition and learning on the two signals can be achieved, and be able to reverse repeat successfully.

Finally, it should be noted that the implementation disclosed is intended to facilitate further understanding of the present invention, but those skilled in the art could understood that various alternatives and modifications are possible without departing from the spirit and scope of the present invention and the appended claims. Accordingly, the present invention should not be limited to the contents disclosed by the embodiment. The scope of the present invention is defined by the scope of the claims.

What is claimed is:

1. A time correlation learning neuron cell circuit, including two neuron cell circuits (1) and (2), and a resistive memristor (3) as a synapse connection between the two neuron cell circuits, each neuron cell circuit further including a excitation signal terminal P, a synapse connection terminal M, a buffer, a control signal inverter N1, a first transmission gate T1 and a second transmission gate T2; wherein,
an output terminal out of the buffer is connected to the excitation signal terminal P, and an input terminal in of the buffer is connected to one signal terminal of the second transmission gate T2;
an input terminal in of the control signal inverter N1 is connected to the excitation signal terminal P, a positive control terminal S of the first transmission gate T1 and a negative control terminal S̅ of the second transmission gate T2, and an output terminal out of the control signal inverter N1 is connected to a negative control terminal S̅ of the first transmission gate T1 and a positive control terminal S of the second transmission gate T2;
one signal terminal of the first transmission gate T1 is connected to a voltage source, the other signal terminal of the first transmission gate T1 is connected to the synapse connection terminal M, the positive control S of the first transmission gate T1 is connected to the excitation signal terminal P, and the negative control terminal S̅ of the first transmission gate T1 is connected to the output terminal out of the control signal inverter N1;
one signal terminal of the second transmission gate T2 is connected to the input terminal in of the buffer, the other signal terminal of the second transmission gate T2 is connected to the synapse connection terminal M, the positive control terminal S of the second transmission gate T2 is connected to the excitation signal terminal P, and the negative control terminal S̅ of the second transmission gate T2 is connected to the output terminal out of the control signal inverter N1.

2. The time correlation learning neuron cell circuit according to claim 1, wherein the resistive memristor (3) is a sandwich structure, including a top electrode (31), a bottom electrode (32), and a resistive material (33) filled between the top electrode (31) and the bottom electrode (32).

3. The time correlation learning neuron cell circuit according to claim 2, wherein the resistive memristor is a resistor programmed by a voltage, and is divided into a unipolar resistive memristor and a bipolar resistive memristor according to a polarity of a programming voltage.

4. The time correlation learning neuron cell circuit according to claim 2, wherein the two neuron cell circuits are a front neuron cell circuit (1) and a back neuron cell circuit (2), respectively, wherein a control terminal of the first transmission gate T1 of the front neuron cell circuit (1) is connected to a positive voltage source Vp, and a control terminal of the first transmission gate T1 of the back neuron cell circuit (2) is connected to a negative voltage source Vn.

5. The time correlation learning neuron cell circuit according to claim 4, wherein a synapse connection terminal P of the front neuron cell circuit (1) is connected to the top electrode (31) of the resistive memristor (3) by metal connection wires; a synapse connection terminal P of the back neuron cell circuit (2) is connected to the bottom electrode (32) of the resistive memristor (3) by metal connection wires.

6. The time correlation learning neuron cell circuit according to claim 1, wherein the buffer is an even number of inverters connected in series.

7. The time correlation learning neuron cell circuit according to claim 1, wherein the excitation signal terminals P of the neuron cell circuits are used as input terminals of excitation signals, and also used as output terminals of excitation signals.

8. An implementation method of a time correlation learning of a time correlation learning neuron circuit according to claim 1, wherein comprising the steps of:
Firstly, creating a correlation
1) two neuron cell circuits receive two different excitation signals from excitation signal terminals respectively;
2) the two excitation signals overlap in time, and during the overlapping period of time, a resistance value of a resistive memristor is gradually decreased;
3) when one of the two excitation signals ends, the resistance value of the resistive memristor will be constant.
Secondly, repeating
When receiving a previous learned excitation signal again, any one of the two neuron cell circuits will affect another neuron cell circuit by a stress signal itself through the resistive memristor, and the another neuron cell circuit generates a corresponding excitation signal.

9. The implementation method according to claim 8, wherein, in the first step, an excitation signal terminal P of the neuron cell circuit is used as an input terminal of the excitation signal, and the excitation signal is input from the excitation signal terminal and is connected to a positive control terminal S of a first transmission gate T1, thereby a voltage source signal which is provided by a voltage source is applied to a synapse connection terminal M by turning on the first transmission gate T1 and turning off a second transmission gate T2.

10. The implementation method according to claim 8, wherein, in the second step, an excitation signal terminal P of the neuron cell circuit is used as an output terminal of the excitation signal, and an input terminal of a buffer is connected to a synapse connection terminal M.
